(19) United States
(12) Patent Application Publication
(10) Pub. No.: US 2015/0178808 A1
(43) Pub. Date: Jun. 25, 2015

(54) PRICE TRANSPARENCY SEARCH AND BUNDLING FOR SURGERIES AND MEDICAL PROCEDURES AND SERVICES

(71) Applicants: Marc A. Grossman, Anaheim Hills, CA (US); Dante Panella, Odessa, FL (US)

(72) Inventors: Marc A. Grossman, Anaheim Hills, CA (US); Dante Panella, Odessa, FL (US)

(21) Appl. No.: 14/641,066

(22) Filed: Mar. 6, 2015

Related U.S. Application Data
(63) Continuation-in-part of application No. 14/296,198, filed on Jun. 4, 2014.
(60) Provisional application No. 62/066,809, filed on Oct. 21, 2014.
(60) Provisional application No. 61/876,622, filed on Sep. 11, 2013.
(60) Provisional application No. 61/631,585, filed on Jan. 9, 2012.

(51) Int. Cl. G06Q 30/06; G06Q 30/02

(52) U.S. Cl. CPC G06Q 30/0625; G06Q 30/0629; G06Q 30/0256; G06Q 30/0273; G06Q 30/0283

(57) ABSTRACT

A system or method for providing price transparency medical procedures or services. The system or method can allow a user to search by desired attributes (e.g., cost, procedure, location, etc.) to obtain, previously unpublished pricing information for medical care. The system or method provides comparison of the costs of in-network and out-of-network medical services and cash-only payments. The user can choose medical care at a desired location, and schedule an appointment. Bundled packages of medical services and ancillary services can be offered to enable the user to compare bundled costs based on in-network and out of network medical services and cash-only payments. Any costs calculated by the system or method can account for copayments and deductibles and can enable a user to compare total out-of-pocket expenses with a cash-only payment option. Advertisement revenue can be obtained on a click-through basis based on a healthcare provider profile.

### CROSS REFERENCE TO RELATED APPLICATIONS

This application claims the benefit of U.S. Provisional Patent Application Ser. No. 62/066,809, filed on Oct. 21, 2014, entitled “PRICE TRANSPARENCY SEARCH AND BUNDLING FOR SURGERIES AND MEDICAL PROCEDURES AND SERVICES,” which is hereby incorporated by reference in its entirety. This application is also a continuation-in-part of U.S. patent application Ser. No. 14/296,198, filed on Jun. 4, 2014, entitled “PRICE TRANSPARENCY SEARCH AND BUNDLING FOR SURGERIES AND MEDICAL PROCEDURES AND SERVICES,” which claimed the benefit of both U.S. Provisional Patent Application Ser. No. 61/876,622, filed on Sep. 11, 2013, entitled “PRICE TRANSPARENCY SEARCH AND BUNDLING FOR SURGERIES AND MEDICAL PROCEDURES AND SERVICES,” and U.S. Provisional Patent Application Ser. No. 61/831,585, filed on Jun. 5, 2013, entitled “PRICE TRANSPARENCY SEARCH FOR SURGERIES AND MEDICAL PROCEDURES AND SERVICES.”

### BACKGROUND

1. Field of the Invention

The present invention relates to a method and system for aiding a user in obtaining desired medical procedures or services. More particularly, the present invention relates to a method and system for locating, choosing, comparing costs, and booking medical procedures and services via a central server or computerized network based upon parameters input or identified by a user. The cost comparison can include a comparison of in-network medical procedures or services, out of network medical procedures or services, and cash-only payment by the user for the medical procedures or services before they are rendered.

2. Description of the Related Art

As health care costs in the United States and elsewhere around the world continue to rise, individuals seeking medical treatment are frequently subjected to stress, not only over their immediate medical problems, but also regarding the payment for medical services to treat those very problems. Particularly for individuals that are uninsured, underinsured, or self-insured, the high cost of medical treatment can be a significant hardship. Even for those patients fortunate enough to have a medical care plan or medical insurance plan, cost is still a common concern since many plans require the patient to pay substantial sums of money in the form of high deductibles before the carrier will begin payment on medical bills. Oftentimes, the more affordable a plan is to an individual, the higher the deductible that must be paid.

Compounding these issues is the lack of any price transparency for medical care made available to the general public. Unlike many other service professions which outline, in detail, the cost associated with the services up-front, medical care is often provided without an itemized cost estimate provided to the patient. Many times, only insurance companies or other health care plans, such as Medicaid or Medicare, have access to the prices of such services. Patients, therefore, have no idea how much a medical procedure will cost when agreeing to it or even when having the service performed. The expense is typically only known once the patient receives the bill or insurance payment statement, sometimes several months after the procedure has been completed, and the cost is often at prices several times higher than usual reimbursements by third party payers to those same providers. Such is the case even for non-emergency medical procedures. The current system deters patients from seeking out desired care from a variety of potential hospitals, outpatient diagnostic/treatment facilities, or medical personnel. Indeed, many individuals or outpatient diagnostic/treatment facilities are not even aware that medical procedure prices are negotiable or that they can vary wildly even between hospitals that are located in close geographic proximity. This lack of published pricing and the availability of discounts can discourage competition between providers, to the detriment of the patients.

Thus, a method or system of providing consumers with the ability to more effectively or efficiently shop for preferred health care is desired. The method or system would desirably allow potential patients access to prices and costs associated with various procedures to allow those patients to make informed decisions about their health care issues before undergoing a particular procedure. Further, the method or system would desirably allow potential patients access to prices and costs associated with in-network or out of network medical procedures or services, and cash-only payments before any medical procedures or services are rendered.

Moreover, the method or system would desirably allow users to conveniently determine information according to their own subjective desires and to easily navigate such information. For example, an internet service and/or internet web portal could provide an easy-to-use interface for providing the cost comparison. In addition, the method or system would desirably allow users the option of bundling medical procedures and/or ancillary services for lower pricing and/or more convenient shopping.

### SUMMARY

The present invention is related to a method and system for determining cost of desired medical procedures. In one embodiment, a system for determining a medical procedure for a user can include a memory configured to store data and a processor connected with the memory. In some embodiments, based at least in part on information received from the user, the processor can be configured to determine a medical procedure, determine a geographic location for the medical procedure, determine a medical facility for the medical procedure at the geographic location, determine a medical practitioner, and determine a price for the medical procedure using the data stored in the memory.

In another embodiment, a method for providing pricing for medical procedures to a user can include providing a processor and a memory accessible by the processor, receiving, using the processor, user input from the user, determining, using the processor, a medical procedure based on the user input, determining, using the processor, a geographic location for the medical procedure based on the user input, determining, using the processor accessing the memory, a cost for the medical procedure in the geographic location, and displaying, using the processor, the cost to the user.

In another embodiment, a medical system may include a memory configured to store data and a processor connected with the memory and, based at least in part on information provided by a user. The processor may be configured to determine a medical procedure and determine a price for the medical procedure using the data stored in the memory, the price determined based on at least one of an in-network price for the medical procedure, an out-of-network price for the medical procedure, a copayment price for the medical procedure, a deductible price for the medical procedure, and a cash-only price for the medical procedure.

In another embodiment, a method for providing pricing for medical procedures may include providing a processor and a memory accessible by the processor, receiving, using the processor, input from the user, determining, using the processor, a medical procedure based on the input from the user, and displaying, using the processor, the cost to the user for the medical procedure, the cost based on at least one of an in-network price for the medical procedure, an out-of-network price for the medical procedure, a copayment price for the medical procedure, a deductible price for the medical procedure, and a cash-only price for the medical procedure.

In another embodiment, a method of obtaining revenue from a healthcare provider may include providing a processor and a memory accessible by the processor, receiving, using the processor, data associated with at least one of a medical device, a medical procedure, or a medical service offered by the healthcare provider, storing the data in the memory, storing a profile for the healthcare provider in the memory, the profile associated with the data, and associating a keyword with the data stored in the memory.

Some embodiments of the invention may include determining, using the processor, one or more costs of at least one medical procedure or service based on the user input, wherein the cost determination using the processor comprises a comparison of in-network medical procedures or services, out of network medical procedures or services, and cash-only payment by the user for the medical procedures or services before they are rendered.

Some embodiments of the invention comprise a user determining and receiving costs for at least one medical procedure or service through an internet service and/or internet web portal. Some embodiments of the invention include systems, methods, computer program products, and the like, for locating, choosing, and comparing costs, and booking medical procedures and services via a central server or computerized network based upon parameters input or identified by a user. In some embodiments, the internet service and/or internet web portal can comprise, at least one cost comparison tool. In some embodiments, the at least one cost comparison tool is configured to enable a user to display the price based at least in part on at least one of a price for an in-network procedure, a price for an out-of-network procedure, a copayment responsibility, a deductible responsibility, an ancillary service cost, and a cash-only payment. In some further embodiments, the price comprises an out-of-pocket cost based at least in part on a met deductible.

In still another embodiment, a method for providing bundled pricing for medical procedures to a user can include providing a processor and a memory coupled with the processor, determining, using the processor, a medical procedure desired by the user, determining, based on data stored in the memory, a predetermined bundle package having a bundle cost, the bundle package including the medical procedure, displaying, using the processor, the bundle package and the bundle cost to the user, and receiving scheduling information from the user to schedule the medical procedure to be performed for the user.

Some embodiments of the invention further comprise the step of providing a software application configured to be executed on a handheld device, and configured to interface with the processor over the Internet for sending the user input to the processor. In some embodiments, the bundle cost includes a cost comparison based on at least one of a price for an in-network procedure, a price for an out-of-network procedure, a copayment responsibility, a deductible responsibility, an ancillary service cost, and a cash-only payment.

In some embodiments of the method, the software application is configured to display at least one webpage. In some embodiments, the at least one webpage includes at least one cost comparison tool. In some other embodiments, the at least one cost comparison tool is configured to enable a user to display the bundled cost based at least in part on at least one of a price for an in-network procedure, a price for an out-of-network procedure, a copayment responsibility, a deductible responsibility, an ancillary service cost, and a cash-only payment. In some embodiments of the method, the bundled price comprises an out-of-pocket cost based at least in part on a met deductible.

### BRIEF DESCRIPTION OF THE DRAWINGS

The features, objects, and advantages of the present invention will become more apparent from the detailed description set forth below when taken in conjunction with the drawings, wherein:

FIG. 1 shows a block diagram of a system implementing a price transparency medical procedure search according to one embodiment of the present invention;

FIG. 2A shows a flowchart of a method for implementing a price transparency medical procedure search according to one embodiment of the present invention;

FIG. 2B shows a flowchart of a portion of a method for implementing a price transparency medical procedure search according to one embodiment of the present invention;

FIG. 3 shows a display to a user for a query, the display a part of a system implementing a price transparency medical procedure search according to one embodiment of the present invention;

FIG. 4 shows a display to a user with results of a query, the display a part of a system implementing a price transparency medical procedure search according to one embodiment of the present invention;

FIG. 5 shows a flowchart of a method for implementing bundled pricing in a system implementing a price transparency medical procedure search according to one embodiment of the present invention; and

FIG. 6 shows a display to a user with results of a query and the option of bundled packages, the display a part of a system implementing a price transparency medical procedure search according to one embodiment of the present invention.

### DETAILED DESCRIPTION

The detailed description of some embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments can be realized and that logical and mechanical changes can be made without departing from the spirit and scope of the invention. Thus, the detailed description herein is presented for purposes of illustration only and not of limitation. For example, the steps recited in any of the method or process descriptions can be executed in any order and are not limited to the order presented. Moreover, any of the functions or steps can be outsourced to or performed by one or more third parties. Furthermore, any reference to singular includes plural embodiments, and any reference to more than one component can include a singular embodiment.

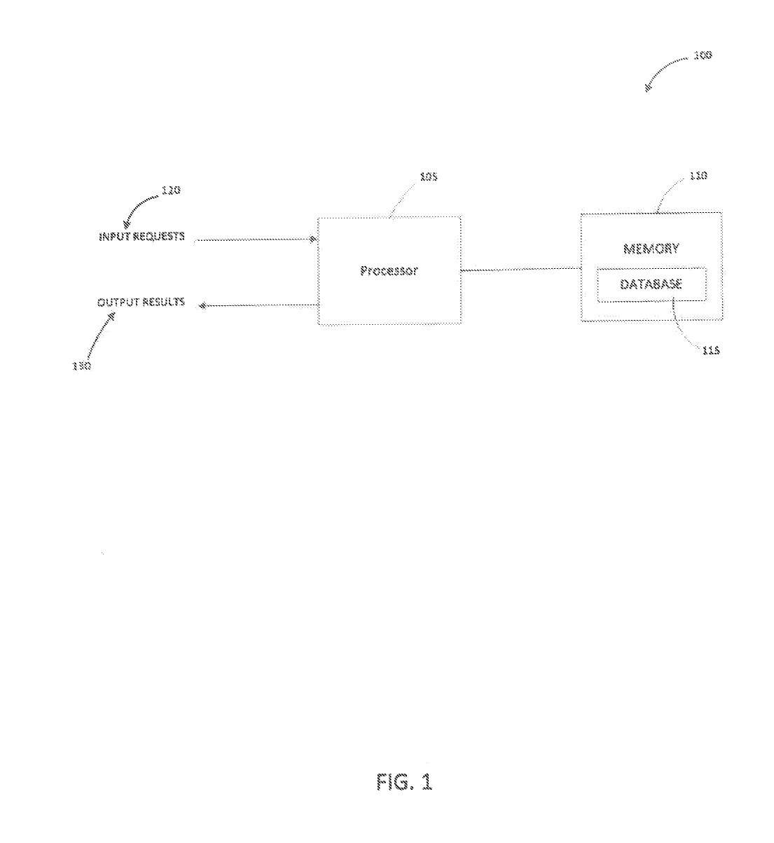

Turning first to FIG. 1, a block diagram of a system 100 implementing a price transparency medical procedure search is shown. As discussed throughout, such a system may be used to provide healthcare information and/or pricing to potential customers (e.g., may be entitled “Healthcare Seeker” or “Healthcare Seeker Technology”). The system 100 includes a processor 105 connected with a memory 110, the memory 110 configured to store data. In some embodiments, the processor 105 is configured to interface or otherwise communicate with the memory 110, for example, via electrical signals propagated along a conductive trace or wire. In an alternative embodiment, the processor 105 can interface with the memory 110 via a wireless connection. In some embodiments, the memory 110 can include a database 115, a plurality of data or entries stored in the database 115 of the memory 110.

As discussed in greater detail herein, in some embodiments, the processor 105 can be tasked with executing software or other logical instructions in order for the price transparency medical procedure search to function as desired. In some embodiments, input requests 120 can be received by the processor 105 (e.g., via signals transmitted from a user at a remote system or device, such as a handheld or mobile device, like a smartphone or tablet, to the processor 105 via a network or internet connection). In an alternative embodiment, the input requests 120 can be received by the processor 105 via a user input device that is not at a geographically remote location (e.g., via a connected keyboard, mouse, etc. at a local computer terminal). In some embodiments, after performing tasks or instructions based upon the user input requests 120, for example, looking up information or data stored in the memory 110, the processor 105 can output results 130 back to the user that are based upon the input requests 120.

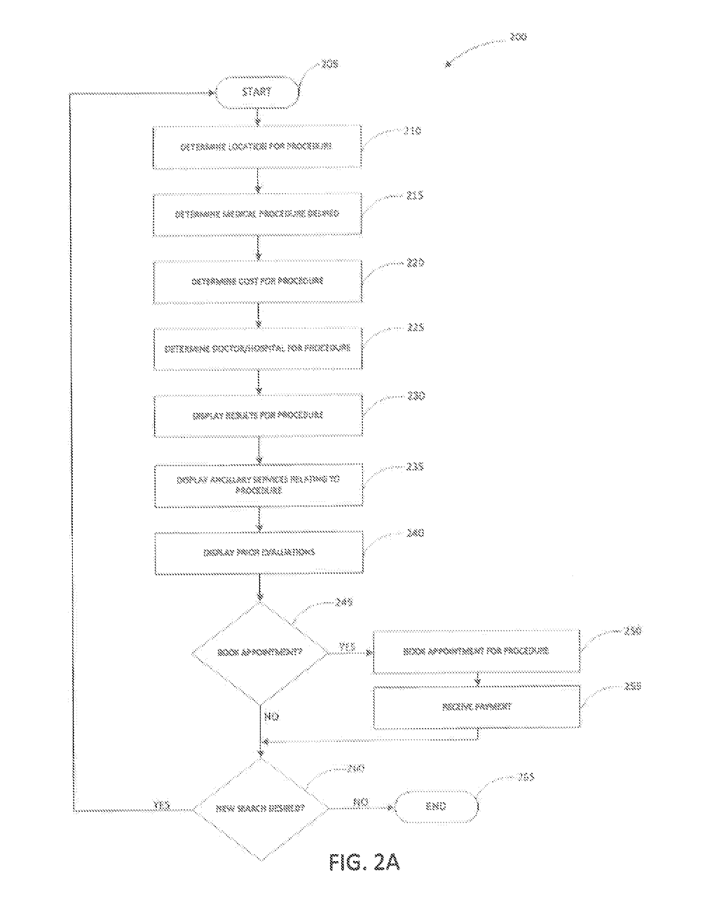

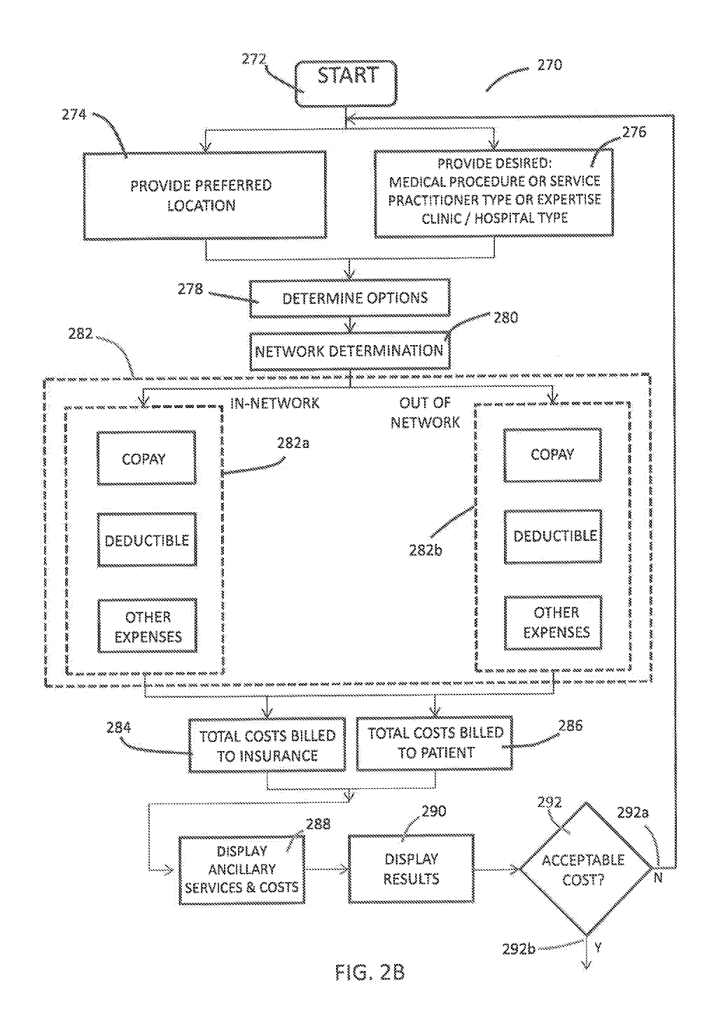

Turning next to FIG. 2A, a flowchart of a process or method 200 for implementing a price transparency medical procedure search is shown. In some embodiments, the process 200 can be implemented in a system that utilizes a processor for evaluating software instructions or code and a memory interfacing with the processor. For example, a system the same as or similar to that described above and shown in FIG. 1 can be used in at least one embodiment of the invention (e.g., utilizing processor 105 and/or memory 110). Thus, in at least one embodiment, a webpage can be established that allows a user to interact with various interactive elements or controls (e.g., drop-down boxes, checkboxes, radio buttons, text boxes, buttons, etc.) in order to determine a desired medical procedure for the user, as discussed in greater detail below. At step 205, the process starts. In one example embodiment, this can occur when a user clicks on a link to arrive at or otherwise enters a webpage URL into an Internet network browser on their personal computer, tablet, smartphone, etc. Other embodiments can utilize alternative ways for allowing user interaction besides a webpage (e.g., a computer software executable, such as a smartphone or tablet application, etc.)

At step 210, the processor can determine a location or geographic area for a medical procedure that is desired by the user. In some embodiments, this can be determined by examining input from the user that is received via one or more interactive elements or controls placed on a webpage. For example, in some embodiments, a dropdown box or a textbox can be disposed on the webpage and ask for the user to indicate, by selecting or typing, respectively, the geographic area where they would like to have a medical procedure performed. The interactive elements may function by asking the user to indicate a city, state, zip code, address, or the like and can also indicate a desired radius (for example, in miles) that represents the maximum geographic distance from the indicated address that the user would be willing to travel for performance of the medical procedure. In some embodiments, a map can be displayed on the webpage to allow the user to graphically pinpoint the address and desired radius upon the graphical map. For example, a user may be allowed to search in a variety of different countries (e.g., United States, Europe, Canada, etc.) or worldwide.

At step 215, the processor can determine a type of medical procedure that is desired by the user. Similar to step 210, this can be determined by examining input from the user that is received via one or more interactive elements or controls placed on a webpage. For example, a dropdown box or a textbox can be disposed on the webpage and ask for the user to indicate, by selecting or typing, respectively, the type of medical procedure they are interested in having performed. Medical procedures of various fields can be determinable, for example, out-patient surgery, GI Labs, LASIK, dental implants, Medi-Spa, etc.

At step 220, a cost for the desired medical procedure in the location or geographic area is determined by the processor. For example, the processor can interface with a memory that contains a database of locations (e.g., hospitals, physician, or other clinics) that are capable of performing the desired medical procedure. Price data may be stored in the database or obtainable by coupling to other databases or servers, the price data being associated with each of those locations for the desired medical procedure. Thus, based on the determination of a desired medical procedure and a desired location for the procedure in steps 215 and 210, respectively, pricing data can be obtained.

The cost or pricing for the procedure can be on an all-inclusive basis (e.g., can include both facility fees and professional fees). Alternatively, the cost or pricing may be piecemeal (e.g., includes only facility fees, professional fees, or other disparate expenses rather than lumped together). Traditional medical services conventionally do not publish costs to cash paying patients or clients that do not utilize an insurance carrier for substantial portions of the bill. Therefore, using the described system and/or process, price discovery or transparency for medical products or services can be provided to customers where it was traditionally not available. In certain embodiments, additional search criteria related to cost can be available as part of the system and/or process. For example, the form of payment that can be used for paying for the procedure or service may be one additional search criteria. Indeed, any of a variety of search criteria can be used in alternative embodiments, in addition to or alternative to those previously described, for example, price, payment type, geographic location, proximity to related facilities (e.g., rehabilitation centers, etc.), doctor experience, hospital familiarity with the procedure, teaching hospital proximity, etc.

At step 225, the processor can determine hospitals or doctors within the desired area or location that are available to perform the medical procedure desired. This can include hospitals, care facilities, and/or doctors that have signed up with the system of search described by FIG. 2A. For example, membership fees can be paid by such hospitals, care facilities, and/or doctors that wish to be searchable by users utilizing the system. In an alternative embodiment, all hospitals, care facilities, and/or doctors can be included in the search whether or not they have agreed to participate in the system. In still another embodiment, hospitals, care facilities, and/or doctors may agree to be included in the system via pricing that has been negotiated with the owner of the system. Advertising revenue based upon clicks from potential patients to those included hospitals, care facilities, and/or doctors, for example, as discussed in greater detail herein, may be obtained by the owner of the system.

At step 230, the results of the determinations made by the processor in steps 210, 215, 220, and/or 225 for the medical procedure can be displayed to the user. The display of the results can be a single location and cost for the medical procedure desired, and/or can be a list of possible locations and corresponding prices that the user can choose amongst. In this manner, the user can browse the list for deciding the best location and/or cost for having the medical procedure performed. The results can all be displayed at once to the user or can be displayed across various screens or tabs that require the user to click or otherwise manipulate a control on a webpage to see additional results. Some embodiments include a webpage here the results can be organized for display according to various schemes from lowest price to highest price, from closest location to furthest location, etc.). In certain embodiments, the user can choose or manipulate how the results are organized for display. In another embodiment, pricing can be determined in step 220 for locations outside of the location determined in step 210, and the user can be prompted as to whether they would desire to see additional results that extend beyond the location previously determined. Further, in some embodiments, a user may choose to accept costs based on one or medical providers where at least a portion of the cost is covered by medical insurance for the user and/or at least a portion of the cost being paid by cash or otherwise out of pocket by the user. In some instances, the user can select to pay at least a portion of the cost even though that portion may be covered by a medical insurance policy covering the user. In other instances, the user can select to pay at least a portion of the cost that may not be covered by a medical insurance policy. In other embodiments, the user can select to pay all of the costs that are displayed in step 230.

At step 235, ancillary services relating to the medical procedure can be displayed to the user. For example, a medical procedure that would require lengthy patient care after surgery, such as physical training to relearn muscle movements, can display memberships to nearby physical training centers that the patient can choose to add to the price of the medical procedure. For example, the user may choose to accept ancillary services costs based on one or more medical providers where at least a portion of the ancillary services cost is covered by medical insurance for the user and/or at least a portion of the ancillary services cost is being paid by cash or otherwise out of pocket by the user. In some instances, the user can select to pay at least a portion of the ancillary services cost even though that portion may be covered by a medical insurance policy covering the user. In other instances, the user can select to pay at least a portion of the ancillary services cost that may not be covered by a medical insurance policy. In other embodiments, the user can select to pay all of the ancillary services costs that are displayed in step 235.

Any of a variety of ancillary services can be displayed that would be relevant to the user considering the medical procedure. In some embodiments, the display of these ancillary services can be on the same page or screen as the results displayed according to step 230. Alternatively or additionally, the display of these ancillary services can be segregated onto a separate link, page or screen for the user to browse if desired. In some embodiments, providers of such ancillary services can sign up with the system with pricing at a discounted rate. In this fashion, both the operator of the system benefits (in the form of a greater number of providers offering services at low prices) and the providers themselves benefit (in the form of increased exposure to potential customers using the system).

At step 240, one or more prior evaluations for the medical procedure (at the location determined in step 210 and/or the hospital or doctor in step 225 and/or in general) can be displayed to the user. Further, in some embodiments, if multiple locations, hospitals, or doctors are displayed to the user in step 230, prior evaluations can be shown to the user, if existing, for each of the display results. These prior evaluations may be aggregated, user submitted evaluations from prior patients that had the medical procedures performed at those locations, hospitals, or doctors. Similar to the discussion above for step 230, the order or organization of the prior evaluations can initially be determined by the processor (e.g., newest evaluations first), but can be modified by the user to have a different organization if desired (e.g., most critical or negative evaluations first). In certain embodiments, users may be able to rate prior evaluations, such as by clicking a link indicating that a particular evaluation was helpful to read. In such embodiments, users may be able to sort or modify the evaluations according to most helpful to least helpful.

In some embodiments, the prior evaluations can be factual data, reviews, data, qualifications, and/or statistics according to other sources, such as the number of times a doctor has performed a particular medical procedure, the number of patients a hospital treats in a year, where a particular doctor went to medical school, etc. Any of a variety of different information can be shown to the user for the purposes of providing data about the individuals or facilities involved in the performance of the medical procedure to aid the user in choosing their preferred doctor, hospital, and/or other metric. For example, one user may be more concerned about price over any other aspect, while another user may be willing to pay a higher price for a doctor with greater experience in performing the type of medical procedure of interest, or to be seen by a doctor at a preferred facility and/or location.

In certain embodiments, the reviews, data qualifications, and/or statistics as mentioned above can be used in order to determine which search results and/or in which order those results will be displayed to the user in step 230. For example, prompts, queries, or other controls that allow for user manipulation can allow a user to receive information or results more suited to that user's particular interests for aiding in making an informed choice. For example, a user may choose to only see results for doctors above a certain experience level (e.g., number of years practicing, number of procedures performed, etc.) even if such results yield higher costs than would otherwise be displayed. In another example, a user may desire to browse the lowest costs for a medical procedure, but only for those procedures using a doctor above a certain experience level. Similarly, a user may desire to browse the lowest costs for a medical procedure, but only for those procedures at a hospital that have a particular number of those same procedures performed within over a particular period of time. Any of a number of search criteria can be included such that the user may decide which search criteria to limit the search according to those aspects which are most important to them.

At step 245 the system including the processor can determine whether the user wishes to book an appointment for one of the results displayed in step 230. This can occur, for example, in response to the user selecting one of the results displayed and clicking on a link indicating a desire to schedule the medical procedure per the selected result. If an appointment is desired, operation can continue to step 250. If no appointment is desired, operation can continue to step 260, discussed in greater detail below. At step 250, available times and/or dates for the medical procedure at the selected result can be displayed for the user to browse and choose a desired appointment time. In some embodiments, the user may be able to select a desired span of dates or times, and the processor will determine and/or cause to display available appointment times within that span. At step 255, the processor can receive payment information (e.g., a credit card number, a PayPal® account, a deposit account number, etc.) from the user to pay for all or a portion of the medical procedure. In some embodiments, no payment may be required. PayPal® and the PayPal logo are registered trademarks of PayPal, Inc.

Operation can then continue to step 260 to determine whether a new medical procedure search is desired. This can occur, for example, in response to user input indicating they wish to modify a current or already existing search that they have performed or whether they wish to begin a new search from the beginning. If no new search is desired, operation continues to step 265 where the process ends. However, if a new search is desired, operation can continue back to step 205 where the process starts anew. Alternative embodiments can utilize additional or fewer steps than those explicitly shown in the flowchart of FIG. 2A. Certain steps can be combined. Certain steps can be omitted. Additional steps may be inserted. Steps can additionally or alternative be performed in a differing order from those explicitly shown and described herein.

In some embodiments of the invention, the cost for any medical procedure or medical service in a specified location or geographic area (for example, specified by a processor, such as processor 105 or by the patient) can be computed by the processor based on a variety of parameters in addition and/or alternatively to those described earlier. Further, in some embodiments, the cost data computed by the processor can be displayed to a patient in a variety of ways to assist the patient in making an informed decision to proceed with any chosen medical procedure or medical service. For example, the cost for the desired medical procedure or service (e.g., represented by step 220 in FIG. 2A) can be processed by the processor using one or more of the steps illustrated in the flowchart 270 shown in FIG. 2B. Further, in some embodiments, steps 205-240 of the process or method 200 shown in FIG. 2A can be substituted by the steps and methods shown in FIG. 2B (the steps forming the flowchart 270).

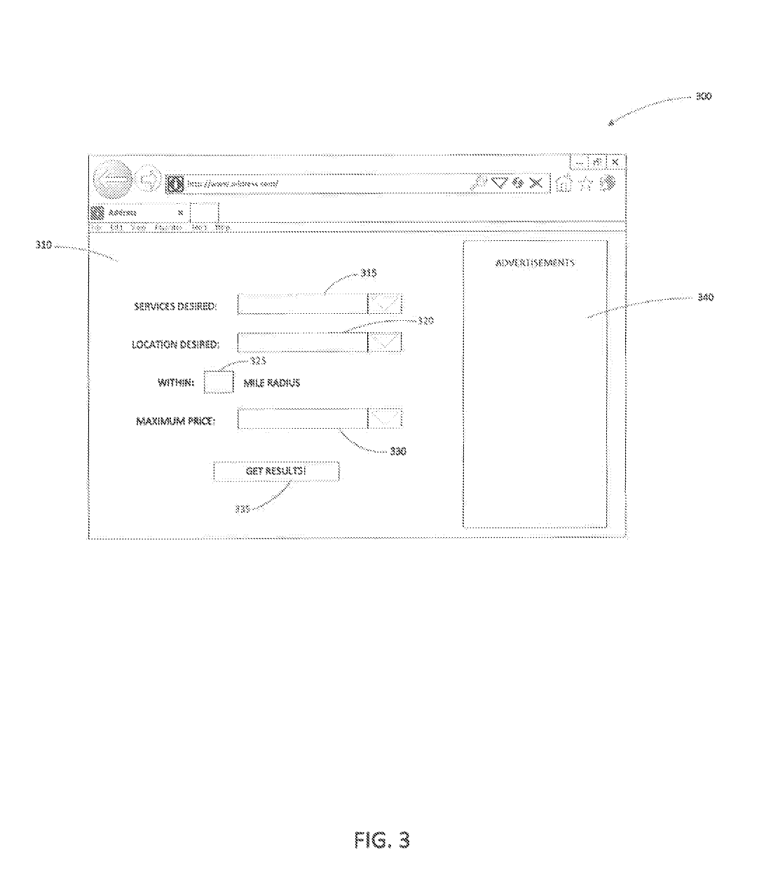

Turning to flowchart 270 of FIG. 2B, and with reference to FIG. 3, in some embodiments of the invention, at step 272, the process starts. In one example, this can occur when a user clicks on a link to arrive at or otherwise enters a webpage URL into an Internet browser on their personal computer, tablet, smartphone, etc. Other embodiments can utilize alternative ways for allowing user interaction besides a webpage (e.g., a computer software executable, such as a smartphone or tablet application, etc.).

At step 274 a patient can be enabled to enter (e.g., select from a drop-down menu and/or web-enabled map) a desired geographic location for the medical procedure or service (e.g., a geographic location where the patient wishes to receive the medical treatment or service). For example, FIG. 3 shows a display 300 that can be presented to a user for a query, where the display 300 comprises a part of a system implementing a price transparency medical procedure search. In some embodiments, the system can include features that are the same as or similar to those previously discussed. For example, in sonic embodiments, the display 300 can be part of a system that allows a user to search for information regarding a desired medical procedure, as discussed in relation to the embodiments of FIGS. 1, 2A and/or 2B. As illustrated, some embodiments of the invention can include a display 300 that can comprise a webpage that is accessed using a standard Internet browser (e.g., Internet Explorer®, Google Chrome®, Mozilla Firefox®, etc.) and includes content 310 that is displayed in the browser. Internet Explorer® is a registered trademark of the Microsoft Corporation in the United States and/other countries. Firefox® is a registered trademark of the Mozilla Foundation. Google Chrome is a trademark of Google Inc.

In some embodiments, a dropdown box or a textbox can be disposed on the webpage with a query for the user to indicate, by selecting or typing, respectively, the geographic area and/or location where they would like to have a medical procedure or service performed or provided, as discussed in greater detail herein for FIG. 3. The interactive elements can function by asking the user to indicate a city, state, zip code, address, or the like and can also indicate a desired radius (for example, in miles) that represents the maximum geographic distance from the indicated address that the user would be willing to travel for performance of the medical procedure.

A step 276 can enable the patient to enter a desired medical procedure or service. In some embodiments of the invention, the display 300 can include a first dropdown box 315 that can allow a viewer of the display 300 to choose a desired medical service or procedure from a pre-generated list. In some alternative embodiments of the invention, other forms of controls or elements in place of or in addition to the first dropdown box 315, or any of the other controls or elements discussed herein can be used for allowing a user to indicate a desired medical service or procedure.

Like mentioned above, in some embodiments, the display 300 can include a second dropdown box 320 that allows the viewer of the display 300 to choose a desired location for the medical service or procedure to be performed from a pre-generated list. In some embodiments of the invention, a textbox 325 can enable the viewer to further indicate a desired distance from the chosen location that would be desirable. Further, in some embodiments, other forms of controls or elements in place of or in addition to the second dropdown box 320 and/or the textbox 325 can be used for allowing a user to indicate a desired location. In some embodiments, a map can be displayed on the webpage to allow the user to graphically pinpoint the address and desired radius upon the graphical map. Certain embodiments can allow a user to search in a variety of different countries (e.g., United States, Europe, Canada, etc.) or worldwide. Once a patient has made a selection, the processor can examine input from the user that is received via one or more interactive elements or controls placed on a webpage.

In some embodiments, the patient can be presented with an option to select a type of medical practitioner (such as a family doctor, an internist, a nurse practitioner, a specialist and/or surgeon, etc.). In some further embodiments, the step 276 can also enable a patient to specify a type of medical facility or clinic. For example, a patient can select a family clinic, an emergency clinic, a general hospital, an emergency hospital, and/or surgery, etc.

At step 274, the processor can determine a location or geographic area for a medical procedure that is desired by the user (as selected in during step 276 described above) based at least in part on the information provided by the patient in step 276. For example, the processor can interface with a memory that contains a database of locations (e.g., hospitals, physician, or other clinics) that are capable of performing the desired medical procedure. In some embodiments, the medical procedure or service can be available near a geographic location preferred by the patient. In other embodiments, the medical procedure or service can be available some distance from the geographic location preferred by the patient. In sonic embodiments, when presented with a plurality of choices, using web-page enable procedures similar or substantially the same as described above with respect to the embodiments depicted in FIG. 3, the patient can be presented with an option to choose one or more option based on geographic preference. For example, a patient can select at least one choice based on how close the medical procedure or service provider is to their home or office or other desired geographic location. Certain patients may be willing to travel to a specific geographic location base on preference, personal or business travel, or other factors important to the patient.

In some other embodiments of the invention, the preferred location (for receiving or accessing a medical procedure or service) can default to the home of the patient, a business or place of work of the patient, a home, work, or business of a relative of the patient, or the patient's actual location (e.g., the current location of the patient while interacting with the system). In certain embodiments, the patient's location can be determined based at least in part on the location of device used to display and interact with the patient. For example, the device location can be determined by an IP address. In another example, the device location can be determined by a GPS coordinate. In still another example, the device location can be determined by at least one wireless signal from the device.

Depending at least on the information provided by the patient and/or information processed by the processor during performing the method comprising step 274 and/or step 276, one or more potential medical delivery options can be determined by the patient and/or the processor. For example, at step 278, in some embodiments, the processor can determine medical delivery options within the desired, selected, or calculated area or location that are available to perform the medical procedure desired. These options may be further determined in conjunction with step 280, as discussed in greater detail below.

In some embodiments, these medical delivery options can include hospitals, care facilities, clinics, doctors, and/or specialists that have signed up with the system of search described by FIG. 2B. In some embodiments, membership fees can be paid by such hospitals, care facilities, clinics, doctors, and/or specialists that wish to be searchable by users utilizing the system and methods described herein. In an alternative embodiment, all hospitals, care facilities, clinics, doctors, and/or specialists can be included in the search whether or not they have agreed to participate in the system and methods described herein. In still another embodiment, hospitals, care facilities, and/or doctors may agree to be included in the system via pricing that has been negotiated with the owner of the system. Advertising revenue based upon clicks from potential patients to those included hospitals, care facilities, and/or doctors, for example, as discussed in greater detail herein, may be obtained by the owner of the system.

At step 280, the processor determines whether a desired medical procedure or service would be considered in-network or out-of-network for the user. An in-network medical provider can include health care providers and facilities that have fee agreements in place with one or more health insurers. These providers are considered in network for members (e.g., a patient insured through a member network, and, in general, paying lower copayments and deductibles for those member network services). An out-of-network medical provider can include health care providers Who do not have an agreement with a health insurer. These providers are generally considered out-of-network, and patients who select and receive medical care from an out-of-network provider or facility do not have the advantage of a negotiated rate, and services rendered may be more expensive and/or may not be completely covered the patient's health plan.

Other aspects of the patient's financial responsibility can also be affected by whether the healthcare provider is in-network or out-of-network. For example, a patient's copayment or “copay” can depend on whether the healthcare provider is considered in-network or out-of-network. In the United States, a copayment is typically a payment defined by a medical insurance policy, and is generally paid by the insured person each time a medical service is provided. Depending on the patient's health insurance plan, a copay may or may not be applied to the patient's deductible. The patient's deductible can also be affected by whether the healthcare provider is in-network or out-of-network, and is generally lower for in-network providers offering comparable care.

Other expenses that can also be affected by whether the healthcare provider is in network or out-of-network can in dude a coinsurance payment (such as a percentage payment after the patient's deductible up to a defined limit). Typically, the coinsurance payment must be paid before any policy benefit is payable by an insurance company, and is applied towards any policy out-of-pocket maxima.

This determination of step 280 may be based upon input received from the user (e.g., response to a query asking for information about the user's medical insurance and/or lookup of what services and/or procedures are considered in-network and/or out-of-network based upon that user's medical insurance). At step 278, the processor can determine and generate in-network and/or out-of-network medical delivery options based at least in part on information provided by a patient and/or generated by the processor in step 274 and/or step 276 and/or step 280.

As illustrated in FIG. 2B, following completion of step 280, the processor can determine in-network and out-of-network costs based at least in part on the healthcare provider information from steps 274, 276, 278, 280. For example, the processor can determine costs from any in-network providers (shown as step 282a). In some other embodiments, costs can be determined by any out-of-network providers (shown as step 282b). In some embodiments, one or more costs calculated in either of the steps 282a and 282b can comprise copay costs, deductible costs, other expense costs, and/or a combination thereof. In some embodiments, the out-of-pocket expenses can comprise costs calculated by the processor in either of steps 282a, 282b that are based on the patient's copay and/or the patient's deductible. For example, in some embodiments, the costs displayed can be adjusted based on a patient's copayment responsibility. In some further embodiments, the costs displayed can be adjusted based on a patient's deductible responsibility. In some other embodiments, the costs displayed can be adjusted based on a patient's copayment responsibility and deductible responsibility. In some embodiments, any adjustments to the costs can be based on the patient's prior payment history. For example, an adjustment can be made based on the patient's remaining deductible that comprises an adjusted deductible based on at least one previous medical procedure or service.

In some embodiments, the other expense cost of step 282a and/or 282b can include the aforementioned coinsurance payments, other out-of-pocket expenses, and/or any other expense that the patient can incur that is not covered as part of his or her copay and/or deductible expense. For example, following completion of step 280 or step 278, the processor can determine cash-only costs based at least in part on the healthcare provider information from at least one of the steps 274, 276, 278, and/or 280. In some embodiments, a user (such as a patient) can be an insured and at least partially covered for medical benefits, but may want to compare total costs by comparing the insurance covered cost (or insurance covered potion of the cost) with a cash payment cost that can include instances where the patient pays up to 100% of the cost.

For example, the processor can determine cash-only costs from any in-network providers (shown as step 282a). In some other embodiments, cash-only costs can be determined for any out-of-network providers (shown as step 282b). In other instances, a user may be uninsured, and therefore will need to compare total costs for cash-only payment costs. In some other instances, a user may be uninsured, about to be insured, or in a position to receive future medical insurance, and may want to compare total costs by comparing the insurance covered cost (or insurance covered potion of the cost) with a cash payment cost that can include instances where the patient pays up to 100% of the cost. For example, an uninsured user may want to review medical procedures and services in advance of any future medical insurance coverage, so as to be provided with the option of moving forward with one or more medical procedures or appointments prior to receiving medical insurance, or to delay moving forward with receiving a medical procedures or service prior until the user is at least partially insured for the medical procedures or service.

In some embodiments of the invention, healthcare provider information determined by the processor from step 280 can comprise only in-network providers. In some other embodiments of the invention, the healthcare provider information determined by the processor from step 280 can comprise only out-of-network providers. In some further embodiments, the healthcare provider information determined by the processor from step 280 can comprise a combination of in-network providers and out-of-network providers. For example, in some embodiments, depending on information from any one or combination of steps 274, 276, and/or 278, the medical delivery can comprise healthcare delivery that comprises an in-network and an out-of-network delivery category.

For example, the healthcare can comprise more than one service and/or procedure, at least one of which is an in-network procedure or service, and at least of which is an out-of-network procedure or service. A component of the medical delivery might comprise being attended by an out-of-network doctor in an in-network medical facility, or vice-versa. Alternatively, in some embodiments, the medical delivery might comprise being attended by one or more out-of-network doctor for at least one component or phase of the medical procedure or service, and one or more in-network doctors for at least one other component, portion, or phase of the medical procedure or service.

In some embodiments of the invention, following the processor calculating one or more costs in step 282 comprising (comprising steps 282a and/or steps 282b), the processor can calculate total costs and display those calculated costs to the patient. In some embodiments, the processor can use price data for copayments, deductibles, in-network expenses, out-of-network expenses, and other expenses as described above, and a combination thereof stored in a database or obtainable by coupling to other databases or servers. Moreover, in some embodiments, the processor can use price data and display costs for cash-only payments. The price data can be associated with each of location, facility, doctor or specialist, and ancillary staff for the desired medical procedure.

The cost or pricing for the procedure can be on an all-inclusive basis (e.g., include both facility fees and professional fees). Traditional medical services conventionally do not publish costs to cash paying patients or clients that do not utilize an insurance carrier for substantial portions of the bill. Using the described process, price discovery or transparency for medical products or services can be provided to customers where it was traditionally not available, including cash-only costs, in addition to partially or fully covered in-network and out-of-network provider costs. In certain embodiments, additional search criteria related to cost can be available as part of the system, for example, the form of payment that can be used for paying for the procedure or service. Indeed, any of a variety of search criteria can be used in alternative embodiments, in addition to or alternative to those previously described, for example, price, payment type, geographic location, proximity to related facilities (e.g., rehabilitation centers, etc.), doctor experience, hospital familiarity with the procedure, teaching hospital proximity, etc.

At step 284, the processor can calculate one or more total costs covered or payable by one or more medical insurers. In some embodiments, the costs may be spread across multiple insurers or a single insurer. In some embodiments, the total cost calculated at step 284 can represent a portion of the total costs calculated in step 282. In some other embodiments, the total cost calculated at step 284 can represent all of the total costs calculated in step 282. Further, in some embodiments, at step 286, the processor can calculate one or more total costs billable to or payable by the patient. The costs calculated by step 284 represent the total cost responsibility of the patient for the medical procedure or service determined in step 276. In some embodiments, the total cost calculated at step 286 can represent a portion of the total costs calculated in step 282. In some other embodiments, the total cost calculated at step 286 can represent all of the total costs calculated in step 282. In some further embodiments, the costs calculated by step 284 can be zero, and the total cost calculated at step 286 can represent 100% of the total cost of the medical procedure or service. For example, this can occur if the procedure is not covered by the user's medical insurance plan, or if the user has chosen a cash-only option.

At step 286, the one or more total costs billable to or payable by the patient can comprise costs calculated by the processor in either of steps 282a, 282b that are based on the patient's copay and/or the patient's deductible. For example, the costs displayed at step 286 can be adjusted based on a patient's copayment responsibility. In another example, the costs displayed at step 286 can be adjusted based on a patient's deductible responsibility. In still another example, the costs displayed at step 286 can be adjusted based on a patient's copayment and deductible responsibility.

In some embodiments, any adjustments can be based on the patient's prior payment history. For example, an adjustment can be made based on the patient's remaining deductible that comprises an adjusted deductible based on at least one previous medical procedure or service. Further, the costs displayed at step 286 may include a comparison of cash-only payment costs compared with out-of-pocket expenses that can comprise copayment costs and/or deductible costs. Further, in some embodiments, the costs displayed at step 286 may include a comparison of cash-only payment costs compared with out-of-pocket expenses that can comprise copayment costs and/or deductible costs.

In some further embodiments, at step 288, ancillary services relating to the medical procedure or service can be displayed to the user. As described earlier with respect to step 235 of FIG. 2A, any of a variety of ancillary services can be displayed that can be relevant to the user considering the medical procedure or service. At step 290, the results of the determinations made by the processor in step 290, and including data from any one or combination of the steps 274, 276, 278, 280, 282, 282a, 282b, 284, 286, and/or 288 for the medical procedure or service can be displayed to the user (such as a patient). In some embodiments, the display of these ancillary services calculated by the processor can be on the same page or screen, for example, as shown displayed according to step 230 of FIG. 2A.

In some embodiments, the display of the results can be a single location and cost for the medical procedure or service desired, selected, or calculated in steps 276, or can be a list of possible locations and corresponding prices that the user can choose amongst. Further, in some embodiments, the user can view cost sub-totals including copayment, deductible, other expenses, etc., as well as view costs displayed for any combination of in-network and out-of-network provider, or for cash-only options. In another embodiment, the user can view a pool of providers and their location, and costs based on in-network, out-of-network, and cash-only payment can be displayed. In this manner, the user can browse the list for deciding the best location and/or cost for having the medical procedure performed. The results may all be displayed at once to the user or, in other embodiments, can be displayed across various screens or tabs that require the user to click or otherwise manipulate a control on a webpage to see additional results. Some embodiments may include a webpage where the results can be organized for display according to various schemes (e.g., from lowest price to highest price, from closest location to furthest location, etc.). In certain embodiments, the user can choose or manipulate how the results are organized for display.

In some further embodiment, the pricing determined in step 290 can be adjusted based on further selection or preferences from the user. For example, in some embodiments, a user can be referred back to any of the steps 274 and/or 276 to modify or change the location and/or any aspect or component of the originally selected or calculated medical procedure or service. In this manner, the results displayed by step 290, as calculated in steps 282, 282a, 282b, 284, 286, and/or 288, can be substantially dynamic based at least in part on one or more additional selections or input from a user. Further, in some embodiments, any results displayed by step 290 can change at any time based on any change to any price data in any database or memory used by the processor.

In some embodiments of the invention, Mowing review of any of the results displayed by step 290, the user can be prompted as to whether they would desire to see additional results that extend beyond the location previously determined. For example, the user can be prompted as to whether they would like to add any additional medical services or procedures, and/or modify any medical services or procedures. In some embodiments, as new information is entered, the processor can dynamically update the displayed cost information in step 290, and/or the user can select to update the cost information at any time.

In some embodiments of the invention, a user can provide updated information in steps 274 and/or 276 based on preferences for one or more in-network or out-of-network providers. In some embodiments, a user can attempt to modify costs displayed by the step 290 by updating input provided to either or both of steps 274 and/or 276. For example, in some embodiments, based at least in part in location information received in step 274, the options determined in step 278 may include only one or more out-of-network providers. In this instance, a user may not wish to use an out-of-network provider and may wish to change information provided in steps 274 or 276, or both. In some embodiments, in decision step 292, if a user decides any of the costs displayed by step 290 are not acceptable, the user can choose a costs not acceptable decision path 292a, and the systems and methods represented by the flowchart 270 can move back to steps 274 and/or 276. In some other embodiments, the user may decide the costs are not acceptable based on any of costs in steps 282a and/or 282b, including, but not limited to copayment cost, deductible cost, cash-only costs, and other expenses associated with the medical procedure or service. Further, in some embodiments, a user can decide on costs not acceptable decision path 292a based at least in part on ancillary costs displayed in step 288 and/or 290.

In some embodiments, the user can select acceptable ranges of costs. For example, referring again to FIG. 3, the display 300 also includes a third dropdown box 330 that allows a viewer of the display 300 to choose a maximum price and/or a price range the viewer would be willing to pay for performance of the medical service or procedure at the location indicated. The third dropdown box 330 (or other, similar dropdown boxes or other input mechanism) can enable a viewer of the display 300 to choose a maximum price the viewer would be willing to pay for an in-network and/or an out-of-network procedure or service. In some other embodiments, the dropdown box 330 (or one or more additional or alternative dropdown boxes) can enable a user to select a similar maximum price and/or a price ranges for copayments, deductibles, other expenses, and any ancillary expenses.

In an alternative embodiment, other forms of controls or elements in place of or in addition to the third dropdown box 330 can be used for allowing a user to indicate their maximum or range of desired price. For example, a button 335 can be clicked by the viewer upon selection or entering of information according to elements 315, 320, 325, and/or 330 to send the selected information to a processor or other component of the system. In certain embodiments, not all of the information shown in FIG. 3 need be submitted or entered before choosing to run a search for results. This information can then be used for determining search results for subsequent display to the viewer.

In some embodiments of the invention, the system can display one or more commercial banners or other advertisements. For example, referring again to FIG. 3, in some embodiments of the invention, advertisements 340 can be shown on the display 300 for providing a source of revenue for the system implementing the display 300. The revenue from advertisements 340 may be the only form of revenue for the system or other streams can be received in conjunction with or in replacement of advertisements 340 in alternative embodiments. For example, participating facilities that perform the medical procedures that are capable of being searched (e.g., hospitals, surgery centers/providers, etc.) can pay an initial membership fee and/or an ongoing monthly maintenance fee to be included as part of the system. In still another example, a participating facility can additionally or alternatively pay a search fee and/or or a click-through fee when a medical procedure is performed due to a searched or scheduled appointment from using the system implementing the display 300.

As previously mentioned, advertising fees from patient click-through may provide revenue (e.g., sole revenue or in combination with other revenue generating schemes) for the owner of the system implementing the display 300 (or any of the other possible embodiments discussed throughout). For example, the system may be a platform that allows physicians, healthcare facilities, or other medical providers or care centers to create or allow creation of a profile on the system that lists certain devices, procedures and/or services available. These devices, procedures and/or services listed on the healthcare provider profile may be the same as those discussed herein that are available for potential customer selection and booking. In this manner, in addition or alternatively to the results shown to the user based upon user input previously discussed, a user may also be permitted to visit the profile of a desired healthcare provider (e.g., if a user inputs a specific hospital or geographic region, the results shown to the user by the system may include links to the profile page for such corresponding facilities and include procedures, services, etc. and the costs associated therewith).

This profile and/or the devices, procedures and/or services contained thereon may be associated with keywords or other advertisements (e.g., via Internet search engines or other online locations) that, when clicked by a user, attract patients to that medical providers profile upon the system. As mentioned above, a pay-per-click or click-through fee may be associated with such keywords or other advertisements, such that the medical provider corresponding to the profile pays the click-through fee to the owner of the system upon a successful linking of the potential user or patient to the profile. Thus, the corresponding medical provider may only pay the owner of the system upon successful attraction of a potential customer, rather than having to pay upfront for advertisements that might not bring any customers to the profile.

The owner of the system and/or the healthcare provider may be responsible for determining where such keywords or other advertisements are placed. For example, potential areas might be one or more search engines, advertising networks, television, radio, print ads, etc. Only upon successful click-through or linking of a customer to the profile due to the advertisements would necessitate payment by the healthcare provider. Traditionally, healthcare advertising to attract patients is done by paying monthly subscription fees, a monthly fee to advertisers to create online advertisements, with upfront costs associated with no guarantees of performance. These traditional methods may entail risk since a healthcare provider may or may not receive a patient due to the advertising despite the outlay of expenses. Using the above-described advertising method, a healthcare provider may only pay the owner of the system if a user clicks on an advertisement. In certain embodiments, the healthcare provider may only pay the owner of the system if a user clicks on an advertisement and also subsequently schedules an appointment for a medical device, procedure and/or service.

The owner of the system maintaining the healthcare provider profile may be in charge of managing the keywords and/or advertisements of the healthcare provider profiles. For example, upon choosing to create a profile, the system may automatically determine keywords based upon the devices, procedures, and/or services that are chosen by the healthcare provider to be offered or available as part of the profile. In another embodiment, the keywords may not automatically be generated by the system, but may be determined or selected by the owner of the system (or an employee) such that consistent keywords are used across all healthcare provider profiles. Moreover, in certain embodiments, the system or owner of the system (or an employee) may write content for advertisements, set advertising budgets, and/or determine bidding on terms for advertisements, etc. in order to help save the costs seen by the healthcare provider.

For example, when creating or establishing a profile on the system, a healthcare provider may see a list of keywords that have already been selected by or in the system for advertising purposes and associate their devices, procedures, and/or services with those predefined keywords. In this fashion, by creating the profile, the healthcare provider need not worry about the additional tasks or expenses commonly associated with advertising since it will be handled by the system and/or the owner of the system. In an alternative embodiment, as mentioned above, advertising may be handled in manners in replacement of or in addition to, click-through based advertisement.

These procedures and services listed on the healthcare provider profile may be the same as those discussed herein that are available for potential customer selection and booking. In this manner, in addition or alternatively to the results shown to the user based upon user input previously discussed, a user may also be permitted to visit the profile of a desired healthcare provider (e.g., if a user inputs a specific hospital or geographic region, the results shown to the user by the system may include links to the profile page for such corresponding facilities and include procedures, services, etc. and the costs associated therewith).

In one embodiment, the viewer of the display 300 or user of the system is not charged any fee for use of the system. Alternative embodiments can utilize subscription plans or other monetary compensation from the users.

In some embodiments, if a user is satisfied with the costs displayed in step 292, the user can finish (i.e. stop interactions with the system). In this instance, the user can choose to accept costs based on one or medical providers, and can select costs based on at least a portion of the cost being provided by medical insurance and/or at least a portion of the cost being paid by cash by the user. In some instances, the user can select to pay at least a portion of the cost even though that portion may be covered by a medical insurance policy. In other instances, the user can select to pay at least a portion of the cost that may not be covered by a medical insurance policy. In other embodiments, the user can select to pay all of the costs that are displayed in step 290.

In some further embodiments, the user can proceed to review prior evaluations and/or book an appointment. For example, in some embodiments, after step 292b, the system can proceed with the steps and methods shown in FIG. 2A, including, but not limited to, steps 240, 245, 250, 255, and/or steps 260, 265.

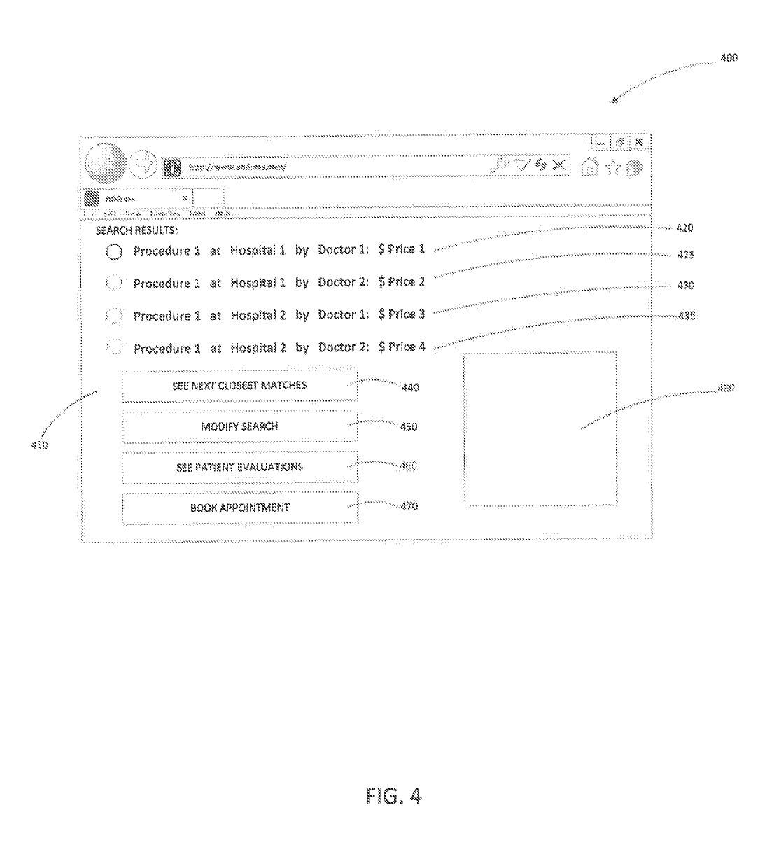

In some embodiments, a user can further review, evaluate, and select one or more procedures or services. For example, FIG. 4 shows a display 400 to a user with results of a query, the display 400a part of a system implementing a price transparency medical procedure search. The system can include features that are the same as or similar to those previously discussed. For example, the display 400 can be part of a system that allows a user to search for information regarding a desired medical procedure or service, such as previously discussed for FIGS. 1, 2A-2B, and/or 3. As illustrated, the display 400 can be a webpage that is accessed using a standard browser (e.g., Internet Explorer®, Google Chrome®, Mozilla Firefox®, etc.) and includes content 410 that is displayed in the browser.

The display 400 may include a plurality of search results (420, 425, 430, 435). These search results (420, 425, 430, 435) can be the result of a processor receiving user input data from a user or viewer of the system implementing the display 400 and using the data to search in a database or other memory for obtaining price or cost information, for example as discussed above in FIGS. 1, 2A-2B, and/or 3. For example, as illustrated, if a user of the system indicated a desired medical procedure (e.g., “Procedure 1” and indicated a desired location (e.g., location encompassing “Hospital 1” and “Hospital 2” within its borders, with “Doctor 1” and “Doctor 2” in such area and available to perform particular medical procedure), those four search results (420, 425, 430, 435) and their associated costs (e.g., “Price 1,” “Price 2,” “Price 3,” and “Price 4,” respectively) can be shown. In some embodiments, if additional search results exist based on the desired medical procedure and location, the user of the system can click a button 440 to receive additional results. In an alternative embodiment, greater or fewer numbers of search results can be displayed to a user in any of a variety of possible formats (e.g., displayed one per page, displayed per location, etc.).

In some embodiments, if the user wishes to modify the search in some fashion, the button 450 can be pressed. This can present a query screen (e.g., display 300 of FIG. 3) to the user. If the user wishes to see patient evaluations, for example, user evaluations, reviews, data, qualifications, and/or statistics, the same as or similar to those previously discussed, button 460 can be pressed. In some embodiments, the search results (420, 425, 430, 435) can be presented as radio buttons such that the user can click to select one or more of the search results (420, 425, 430, 435) and then press the button 460 to get detailed information that is relevant to the selected search result. Likewise, if a particular search result is desirable to a user, the user can click to select such search result and then press a button 470 allowing them to book or schedule an appointment for the medical procedure. Similar to FIG. 3, advertisements 480 can be provided on the display 400 for providing a source of revenue for the system implementing the display 400.

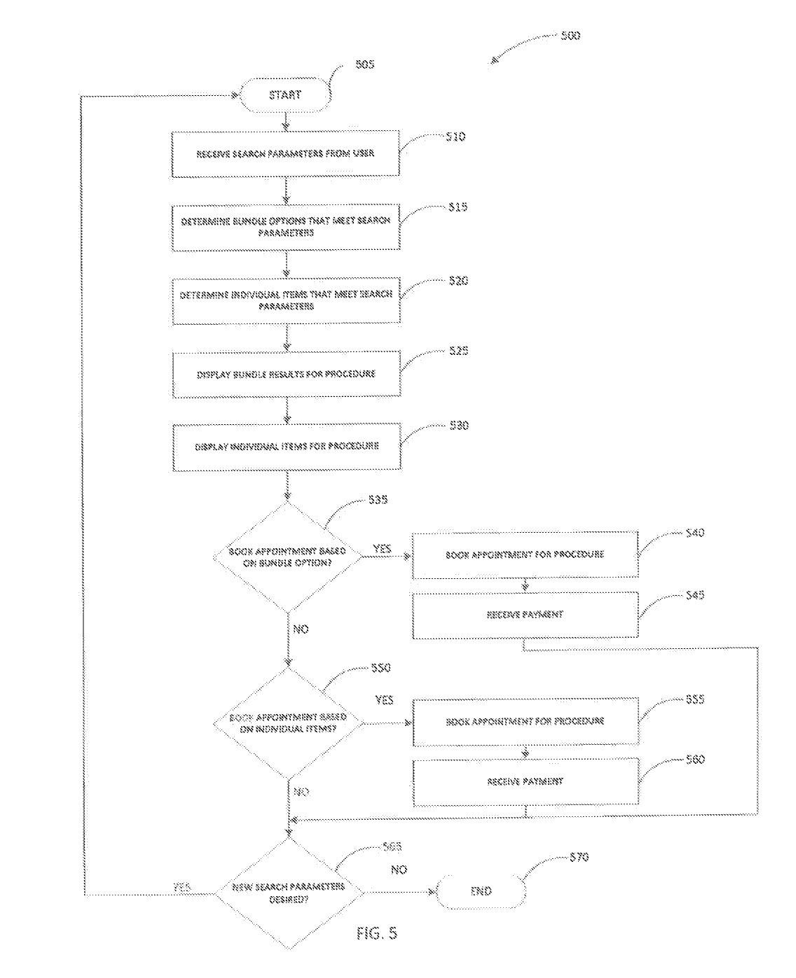

Turning next to FIG. 5, a flowchart of a process or method 500 for implementing a price transparency medical procedure search with bundling is shown. The process or method can include features that are the same as or similar to those previously discussed, and can comprise information derived from any of the systems and methods embodied by the steps shown in FIGS. 2A and 2B, or a combination thereof. In some embodiments, the bundled costs can comprise costs associated with one or more providers, including in-network and/or out-of-network providers. In other embodiments, the bundled costs can include one or more bundled cash-only options. For example, in reference to the example embodiments illustrated in FIG. 2B, following completion of step 280 or step 278, the processor can determine cash-only costs based at least in part on the healthcare provider information from at least one of the steps 274, 276, 278, and/or 280. In some embodiments, the processor can determine cash-only costs from any in-network providers (shown as step 282a), and/or for any out-of-network providers (shown as step 282b). In some embodiments, a user can compare total costs for cash-only payment costs, and can view a cash payment cost that can include instances where the patient pays up to 100% of the cost. Using these methods, a user can be provided with the option to view cash-only bundled cost before receiving a medical procedures or service.

In FIG. 5, a selection of predetermined bundle packages can be determined for the user and displayed to the user for selection, as discussed in greater detail herein. The process or method 500 can be implemented in a system that utilizes a processor for evaluating software instructions or code and a memory interfacing with the processor (e.g., as previously discussed for FIG. 1). A system the same as or similar to those previously described can be used in one embodiment. Thus, in at least one embodiments, a webpage can be established that allows a user to interact with various interactive elements or controls (e.g., drop-down boxes, checkboxes, radio buttons, text boxes, buttons, etc.) in order to determine a desired medical procedure for the user, as discussed in greater detail below. Moreover, a user determines and/or receiving costs for at least one medical procedure or service can receive the cost information through an internet service and/or internet web portal. In some embodiments, the internet service and/or internet web portal can provide an interface including tools for providing the cost comparison. More specifically, in some embodiments, the cost comparison or cost comparison tool can be accessed through single internet service and/or internet web portal without the need to switch between multiple internet services and/or internet web portals. In some embodiments, the cost comparison displayed through the internet service and/or internet web portal can include an insured component, a non-insured component, and/or a cash-only payment option component.

At step 505, the process starts. In some embodiments, this can occur when a user clicks on a link to arrive at or otherwise enters a webpage URL into an Internet browser on their personal computer, tablet, smartphone, etc. At step 510, the processor (e.g., processor 105 as discussed previously for FIG. 1) can receive search parameters from the user. This can occur by allowing the user to type, click, or otherwise select among different criteria medical procedures, surgeries, medical services, date/time, geographic location, hospital, doctor, etc.) in order to determine the interests of the user. This can be determined by examining input from the user that is received via one or more interactive elements or controls placed on a webpage using the system and methods embodied by either of FIGS. 2A and 2B as described earlier. For example, a dropdown box or a textbox can be disposed on the webpage and ask for the user to indicate, by selecting or typing, respectively, the geographic area where they would like to have a medical procedure performed. The interactive elements or controls can be located upon a single webpage screen or can span a plurality of webpage screens which a user clicks through and makes selections thereon.

The same as or similar to the previous discussions, the interactive elements can function by asking the user to indicate a city, state, zip code, address, or the like and can also indicate a desired radius (for example, in miles) that represents the maximum geographic distance from the indicated address that the user would be willing to travel for performance of the medical procedure. In some embodiments, a map can be displayed on the webpage to allow the user to graphically pinpoint the address and desired radius upon the graphical map. Certain embodiments can allow a user to search in a variety of different countries (e.g., United States, Europe, Canada, etc.) or worldwide.

In some embodiments, at step 515, the processor can determine one or more bundle options or packages that meet one or more of the search parameters received in step 510. The bundle options or packages can represent groups or collections of medical procedures/services and/or other types of services or items that are combined together into one selectable package by the user. A bundle cost or price for each of the bundle options or packages can also be determined in some embodiments. In at least one embodiment, the bundle cost is a lower cost than if the user had opted to individually select each of the medical procedures/services and/or other types of services or items that are combined together to form the bundle. For example, this lower cost can be obtained by having predetermined contracts or agreements with particular vendors of goods or services, where they agree to offer such goods or services at a lower price in order to be included in the bundle packaging. In other words, in some embodiments, the particular vendors of goods or services can comprise in-network providers as discussed earlier. In one embodiment, only bundle options or packages that meet all of the user-desired search parameters in step 510 are determined for selection. In an alternative embodiment, bundle packages can be determined for selection by the user if they meet only some of the search parameters in step 510, but not all of them. In some embodiments, the cost comparison displayed can include an insured component. In other embodiments, the cost comparison can exclude an insured component. For example, the cost component can comprise a cash-only comparison of bundled packages.

At step 520, the processor can determine individual items that can be selected by the user for purchase that meet one or more of the search parameters received in step 510. A corresponding cost for each of the individual items may also be determined. Similar to previous discussions, price data for a variety of medical procedures, services, and/or ancillary goods or services can be stored in a database or otherwise obtainable by connection to a remote system or server and obtained when the search parameters received in step 510 indicates such medical procedures, services, and/or ancillary goods or services meet the user's desires.

At step 525, the results of the determination made by the processor in step 515 can be displayed to the user. In some embodiments, the display of the results can be a single bundle package with a corresponding bundle cost that was determined to meet the user's search parameters from step 510, or can be a list of bundle packages with corresponding bundle prices. In this manner, the user can browse the list for deciding the bundle package according to their preferences. The results can all be displayed at once to the user or can be displayed across various screens or tabs that require the user to click or otherwise manipulate a control on a webpage to see additional results. The results can be organized for display according to various schemes (e.g., from lowest price to highest price, from closest geographic location to furthest geographic location, etc.) Further, in some embodiments of the invention, a user can provide updated information (e.g., in steps 274 and/or 276 as previously discussed for FIGS. 2A and/or 2B) based on preferences for one or more in-network or out-of-network providers, copayment cost, deductible cost, cash-only cost, and other expenses associated with the medical procedure or service. In some embodiments, a user can attempt to modify costs displayed by updating input provided to either or both of steps 274 and/or 276. For example, in some embodiments, preferences for in-network or out-of-network providers copayment cost, deductible cost, cash-only cost, and other expenses associated with the medical procedure or service can be provided or updated. In certain embodiments, the user can manipulate how the results are organized for display.

Similarly, at step 530, the results of the determination made by the processor in step 520 are displayed to the user. The display of the results includes each of the individual procedures, services, and/or items and a corresponding cost or price for each individual procedure, service, and/or item that were determined in step 520 to match the user's search parameters in step 510. In this manner, if the user would rather choose specific options, rather than the, perhaps more limited, options available in the bundle packages, the user is free to select according to those precise desires. For example, while the bundle results displayed in step 525 can only correspond to particular hospitals, doctors, etc. that have agreed to offer their goods or services for a reduced cost as part of bundle deals, if the user desires a specific hospital or doctor not among the bundled options, the user can choose according to those preferences via the procedures, services, and/or items.

In some embodiments, the results displayed to the user can comprise bundled costs calculated by the processor based on the patient's copay and/or the patient's deductible. For example, in some embodiments, the bundled costs can be adjusted based on a patient's copayment responsibility. Further, in some embodiments, the bundled costs displayed can be adjusted based on a patient's deductible responsibility. In some embodiments, the bundled costs displayed can be adjusted based on a patient's copayment and deductible responsibility. In some embodiments, any adjustments to the bundled cost can be based on the patient's prior payment history. For example, in some embodiments, an adjustment can be made based on the patient's remaining deductible that comprises an adjusted deductible based on at least one previous medical procedure or service. Further, in some embodiments, the bundled costs can comprise a comparison of cash-only payment costs compared with out-of-pocket expenses that can comprise copayment costs and/or deductible costs.

In at least one embodiment, the cost to the user for making individual selections can be greater than if the same selections were Chosen as part of a bundled package. The same as or similar to the previous discussion, the results can all be displayed at once to the user or can be displayed across various screens or tabs that require the user to click or otherwise manipulate a control on a webpage to see additional results. The results can be organized for display according to various schemes (e.g., from lowest price to highest price, from closest geographic location to furthest geographic location, etc.). In certain embodiments, the user can manipulate how the results are organized for display.

At step 535, it can be determined whether the user wishes to book an appointment for one of the bundle package options displayed in step 525. This can occur, for example, in response to the user selecting one of the bundle options displayed and clicking on a link indicating a desire to schedule an appointment per the selected result. In some embodiments, the user can be presented with an option to book an appointment, for one of the bundle package options displayed in step 525 that comprise an insurance-paid cost portion. In some other embodiments, the user can book an appointment for one of the bundle package options displayed in step 525 that comprises a cash-only portion. In some embodiments, the cash-only option comprises 100% of the total cost of services to be rendered at the appointment. If an appointment is desired, operation continues to step 540. If no appointment is desired, operation continues to step 550, discussed in greater detail below.

At step 540, available times and/or dates for the medical procedure at the selected result can be displayed for the user to browse and choose a desired appointment time. In some embodiments, the user can be able to select a desired span of dates or times and the processor will determine and/or cause to display available appointment times within that span. In other embodiments, the bundle package can be only for a predetermined date. At step 545, the processor can receive payment information (e.g., a credit card number, a PayPal® account, a deposit account number, etc.) from the user to pay for all or a portion of the bundle package option. In some embodiments, no payment may be required. Operation may then continue to step 565, as discussed in greater detail below.

At step 550, it can be determined whether the user wishes to book an appointment for one or more individual items displayed in step 530. This can occur, for example, in response to the user selecting one or more of the individual items displayed and clicking on a link indicating a desire to schedule an appointment or to purchase the selected result. If an appointment or purchase is desired, operation continues to step 555. If no appointment or purchase is desired, operation continues to step 565, discussed in greater detail below. At step 555, available times and/or dates, if applicable, or other purchase input information as desired for the one or more individual items can be displayed for the user to browse and provide additional information as needed. At step 560, similar to the discussion above, the processor can receive payment information (e.g., a credit card number, a PayPal® account, a deposit account number, etc.) from the user to pay for all or a portion of the individual items that were selected. In some embodiments, no payment may be required.

In some embodiments of the invention, operation then continues to step 565 to determine whether new (e.g., modified) search parameters are desired by the user. This can occur, for example, in response to user input indicating they wish to modify a current or already existing search that they have performed or whether they wish to begin a new search from the beginning. If no new search parameters are desired, operation continues to step 570 where the process ends. However, if new search parameters are desired, operation continues back to step 505 where the process starts anew. Alternative embodiments can utilize additional or fewer steps than those explicitly shown in the exemplary flowchart of FIG. 5. Certain steps can be combined. Certain steps can be omitted. Additional steps may be inserted. Steps can additionally or alternative be performed in a differing order from those explicitly shown and described herein.

Any of a variety of search parameters can be used for generating search results for a user, either for bundle package options and/or for individual item options. For example, in some embodiments, a user can desire to browse bundle package options that are available that include a particular doctor, surgeon, or other medical practitioner at a particular hospital or other medical facility. Further, in some embodiments, any bundle option can include preferences for in-network and out-of-network providers, and selections based at least in part on the patients copayment responsibility, the patients deductible, ancillary expenses, cash-only options, and/or other expenses associated with the medical procedure or service (such as those determined by the system and methods illustrated by the flowchart 270 shown in FIG. 2B).

In this manner, the user can obtain an inexpensive and comprehensive price by browsing and selecting a bundle package option, but still maintain control over the medical personnel and/or facilities performing or involved in the procedure. If a user is instead more interested in price and/or location, and less interested in the medical practitioner and/or facility, those alternative search parameters can be entered by the user and used for determining the search results. By allowing the user flexibility to enter as many or as few search parameters as they desire, more customized search results can be obtained for the user to select amongst.

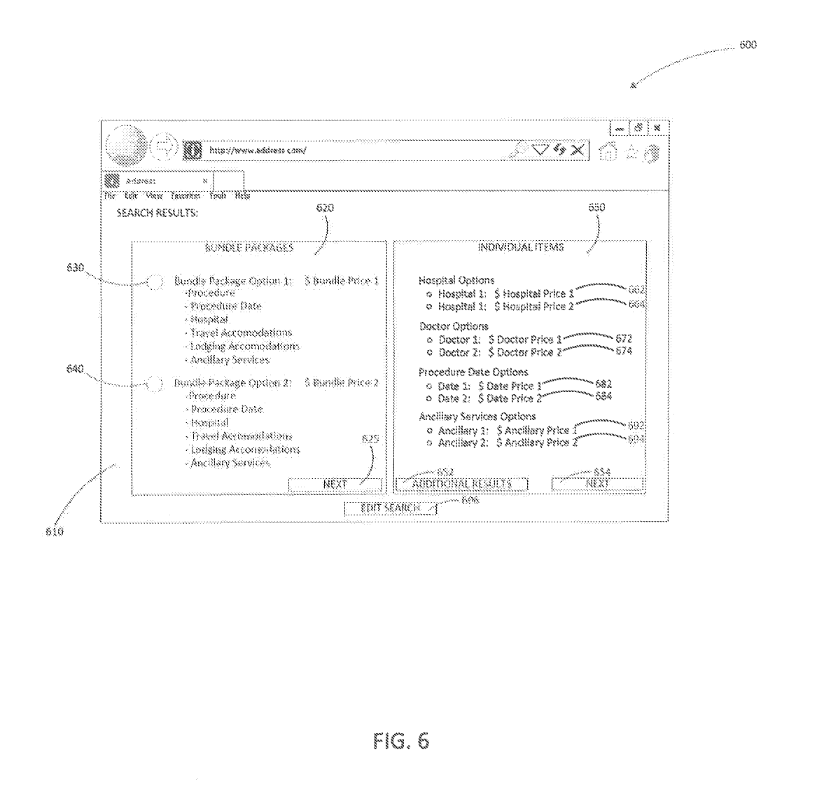

FIG. 6 shows a display 600 to a user with results of a query, the display 600 a part of a system implementing a price transparency medical procedure search with bundling. In some embodiments, the system can include features that are the same as or similar to those previously discussed. For example, the display 600 can be part of a system that allows a user to search for information regarding a desired medical procedure, such as previously discussed in relation to the system and methods depicted in FIGS. 2A, 2B, and/or 3. As illustrated, the display 600 can be a webpage that is accessed using a standard browser (e.g., Internet Explorer®, Google Chrome®, Mozilla Firefox®, etc.) and includes content 610 that is displayed in the browser.

In some embodiments of the invention, the system can use search parameters received from the user in order to determine bundle options and/or individual items to offer for sale to the user, the same as or similar to the previous discussions. After making such determinations, the system showcases such results to the user upon a display screen where the user is able to make selections according to their preferences. The display 600, according some embodiments as illustrated in FIG. 6, includes bundle package options 620 and individual (e.g., a la carte) item options 650 that can be selected by the user for purchase in some embodiments of the invention. Regarding the bundle package options 620, a first bundle package option 630 and a second bundle package option 640 are shown and may be selectable by the user (e.g., by clicking on a radio button, checkbox, or other interactive element that is displayed on the display 600). In an alternative embodiment, greater or fewer bundle package options can be displayed to the user for selection.

The first bundle package option 630 has a corresponding bundle cost or price that represents the cost to the user for all of the goods or services provided as part of the first bundle package option 630. In some embodiments, these costs can be calculated by a processor (e.g., processor 105 of FIG. 1) using any one or combination of embodiments shown in FIGS. 2A-2B, and/or 3. For example, these goods or services can include some or all of the following: a medical procedure to be performed, the date and/or time of the performance of the medical procedure, hospital costs (e.g., room and board, meals, etc.) associated with the performance of the medical procedure, travel accommodations (e.g., airfare, bus fare, train fees, taxi costs, shuttle costs, etc.) in order to locate the user desiring the medical procedure from their residence to the hospital, lodging accommodations (e.g., hotel costs, after-care facilities, etc.) if the user will be away from their residence before and/or after the medical procedure is performed, and other, ancillary services (e.g., after-care treatment such as rehabilitation, etc.).

In some embodiments, any of the costs can comprise costs based on a user selection during any of the systems and methods depicted in FIGS. 2A-2B, and/or 3. The costs may comprise costs derived following a user selection of in-network provider, out-of-network provider, range or maximum of copay, range or maximum of deductible, range or maximum or other expenses, cash-only options, or selection or dc-selection of any ancillary services. Moreover, the costs may comprise bundled costs calculated by the processor based on the patient's copay and/or the patient's deductible. For example, the bundled costs can be adjusted based on a patient's copayment responsibility. Alternatively or additionally, the bundled costs displayed can be adjusted based on a patient's deductible responsibility. In some embodiments, the bundled costs displayed can be adjusted based on a patient's copayment and deductible responsibility.

Adjustments to the bundled cost may be based on the patient's prior payment history. For example, an adjustment can be made based on the patient's remaining deductible that comprises an adjusted deductible based on at least one previous medical procedure or service. Further, in some embodiments, the bundled costs displayed can comprise a comparison of cash-only payment costs compared with out-of-pocket expenses that can comprise copayment costs and/or deductible costs.

Similarly, the second bundle package option 640 has a corresponding bundle cost or price that represents the cost to the user for all of the goods or services provided as part of the second bundle package option 640. The goods or services offered as part of the second bundle package option 640 can be the same as or similar to those offered by the first bundle package option 630, as discussed above. For example, the same goods or services can be offered in both of the first bundle package option 630 and the second bundle package option 640, but at different hospital locations and/or at different dates and/or times. Such differences can result in different associated costs or prices for each of the first bundle package option 630 and the second bundle package option 640. In certain embodiments, the costs associated with the first bundle package option 630 and the second bundle package option 640 can be the same.

By comparing the costs and/or the goods or services offered by the first bundle package option 630 and the second bundle package option 640, the user can decide which bundle is more desirable and opt to select one of the bundles in order to book an appointment for the medical procedure and/or purchase the goods or services being offered. As previously discussed, the system implementing a price transparency medical procedure search with bundling can have contracts, agreements, or other arrangements with various vendors and/or providers of goods or services that have agreed to participate in bundling of their goods or services in exchange for offering such goods or services at a reduced price. For example, a vendor or provider can feel the increased quantity of goods or services sold as a result of bundled participation warrants a reduction in price in order to obtain those sales. In one embodiment and as shown, upon selecting the first bundle package option 630 or the second bundle package option 640, the user can click or select a next button 625 that continues system operation to a booking, reservation, or other purchase setup, for example, as previously discussed.

In order to accommodate users who do not wish to purchase bundle packages (e.g., users with particular preferences for doctors, hospitals, travel arrangements, etc.) the system may also or alternatively allow users to specifically chose individual items that represent goods and/or services based upon the search parameters received from the user. For example, if the user indicated via the search parameters that they currently reside in California and desire Lasik surgery, bundle options can be shown for particular hospitals and/or doctors in the nearby geographic area that have agreed to participate in bundling of corresponding goods and/or services, but the user may have a particular hospital or doctor that they wish to see or may not need or may desire to make their own travel accommodations. Rather than only being able to choose a bundled option, such a user can instead more specifically choose the individual components of or relating to the desired procedure.

In some embodiments of the invention, the display 600 can show to the user the individual item options 650 that can be selected by the user for purchase. The same as or similar to previous discussions, these individual item options 650 can be based upon search parameters previously received from the user, and can include insured costs, uninsured costs, and cash-only payment options. For example, a first hospital option 662 with a corresponding first hospital price, a second hospital option 664 with a corresponding second hospital price, a first doctor option 672 with a corresponding first doctor price, and a second doctor option 674 with a corresponding second doctor price can be shown. In some embodiments, the user can then specifically choose the hospital and the doctor for the procedure.

In addition, a first date option 682 with a corresponding first date price and a second date option 684 with a corresponding second date price can be shown. The user is thus permitted to choose a specific date and/or time for the desired procedure to be performed. In some embodiments, at least some of the procedure can include an insured cost amount. In other embodiments, the desired procedure can be a cash-only option selected by the user.

A first ancillary option 692 with a corresponding first ancillary price and a second ancillary option 694 with a corresponding second ancillary price may also be displayed, allowing users to choose between and/or to choose more than one ancillary service that is related to the desired procedure (e.g., aftercare services, medications purchases, medical equipment purchases, etc.). In some embodiments, one or more of the individual item options 650 are selectable by the user (e.g., by clicking on a radio button, checkbox, or other interactive element that is displayed on the display 600). In an alternative embodiment, greater or fewer individual item options can be displayed to the user for selection.

By comparing the costs and/or the goods or services offered by the various individual item options 650, the user can decide which items are desirable and opt to select one or more of the individual items for purchase. For example, in the example above, in some embodiments, at least a portion of any ancillary price can be selected by a user to be designated as at least partially paid for by any available medical insurance. In other embodiments, the user can select to pay for any ancillary services using a cash-only option.

In some embodiments, and as shown, upon selecting one or more of the individual item options 650, the user can click or select a next button 654 that continues system operation to a booking, reservation, or other purchase setup, for example as previously discussed. If more individual items are available and offered to the user than can be displayed at once on the display 600, the user can click or select an additional results button 652 in order to view a next page or listing of individual item options 650 that can be purchased. If the user decides that either or both of the bundle packages 620 and/or the individual item options 650 do not correspond to their desires, an edit search 696 button can be clicked or selected in order to re-enter or modify some or all of the search parameters.

The previous description of the disclosed examples is provided to enable any person of ordinary skill in the art to make or use the disclosed methods and apparatus. Various modifications to these examples will be readily apparent to those skilled in the art, and the principles defined herein can be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans can implement the described functionality in varying ways for each particular application, but such implementation decisions should not be interpreted as causing a departure from the scope of the disclosed apparatus and methods. The steps of the method or algorithm can also be performed in an alternate order from those provided in the examples.

What is claimed is:

1. A medical system comprising:
a memory configured to store data; and
a processor connected with the memory and, based at least in part on information provided by a user, configured to:
determine a medical procedure, and
determine a price for the medical procedure using the data stored in the memory, the price determined based on at least one of an in-network price for the medical procedure, an out-of-network price for the medical procedure, a copayment price for the medical procedure, a deductible price for the medical procedure, and a cash-only price for the medical procedure.

2. The medical system of claim 1, wherein the price for the medical procedure is determined via a comparison based on an ancillary service price for the medical procedure.

3. The medical system of claim 1, wherein the processor is configured to determine the medical procedure from user input generated via a query screen displayed to a user.

4. The medical system of claim 3 wherein the query screen is a webpage configured to be accessed by the user via the Internet.

5. The medical system of claim 4 wherein the webpage includes a cost comparison tool.

6. The medical system of claim 5 wherein the cost comparison tool is configured to enable the user to display the price for the medical procedure based at least in part on a comparison between at least one of an in-network price for the medical procedure, an out-of-network price for the medical procedure, a copayment price for the medical procedure, a deductible price for the medical procedure, and a cash-only price for the medical procedure.

7. The medical system of claim 1 wherein the price for the medical procedure comprises an out-of-pocket cost based at least in part on the deductible price.

8. A method for providing pricing for medical procedures, the method comprising:
providing a processor and a memory accessible by the processor;
receiving, using the processor, input from the user;
determining, using the processor, a medical procedure based on the input from the user; and
displaying, using the processor, the cost to the user for the medical procedure, the cost based on at least one of an in-network price for the medical procedure, an out-of-network price for the medical procedure, a copayment price for the medical procedure, a deductible price for the medical procedure, and a cash-only price for the medical procedure.

9. The method of claim 8 wherein the cost is based on an ancillary service price for the medical procedure.

10. The method of claim 8, wherein the cost comprises an out-of-pocket cost based at least in part on a met deductible.

11. The method of claim 8, further comprising determining, based on data stored in the memory, a bundle package having a bundle cost, the bundle package including the medical procedure.

12. The method of claim 11, wherein the bundle cost is based on at least one of an in network price for the medical procedure, an out-of-network price for the medical procedure, a copayment price for the medical procedure, a deductible price for the medical procedure, and a cash-only price for the medical procedure.

13. The method of claim 8 further comprising providing a software application for execution on a mobile device, the software application configured to communicate with the processor for sending the input to the processor.

14. The method of claim 13 wherein the software application is configured to display at least one webpage.

15. A method of obtaining revenue from a healthcare provider comprising:
providing a processor and a memory accessible by the processor;
receiving, using the processor, data associated with at least one of a medical device, a medical procedure, or a medical service offered by the healthcare provider;
storing the data in the memory;
storing a profile for the healthcare provider in the memory, the profile associated with the data; and
associating a keyword with the data stored in the memory.

16. The method of claim 15 further comprising negotiating an advertisement configured to be clicked on by a user, the advertisement associated with the keyword.

17. The method of claim 16 further comprising receiving a payment, using the processor, based upon a user clicking upon an advertisement associated with the keyword.

18. The method of claim 15 wherein the payment is received only if the user clicks upon the advertisement associated with the keyword.

19. The method of claim 18 wherein the payment is received only if the user purchases the at least one of the medical device, the medical procedure, or the medical service.

20. The method of claim 15 further comprising:
receiving, using the processor, user input from a user; and
transmitting to the user, using the processor, information corresponding to the profile for the healthcare provider if the user input corresponds to the keyword.
